(19) United States
(12) Patent Application Publication
(10) Pub. No.: US 2017/0322889 A1
(43) Pub. Date: Nov. 9, 2017

(54) COMPUTING RESOURCE WITH MEMORY RESOURCE MEMORY MANAGEMENT

(71) Applicant: HEWLETT PACKARD ENTERPRISE DEVELOPMENT LP, Houston, TX (US)

(72) Inventors: Mitchel E. Wright, Houston, TX (US); Michael R. Krause, Palo Alto, CA (US); Dwight L. Barron, Houston, TX (US); Melvin K. Benedict, Houston, TX (US)

(21) Appl. No.: 15/527,395

(22) PCT Filed: Nov. 25, 2014
(86) PCT No.: PCT/US2014/067247

§ 371 Date: May 17, 2017

(51) Int. Cl. G06F 12/1027

(52) U.S. Cl. CPC G06F 12/1027; G06F 2212/1041; G06F 2212/68

(57) ABSTRACT

In an example implementation according to aspects of the present disclosure, a computing system includes a memory resource having a plurality of memory resource regions and a plurality of computing resources. The plurality of computing resources are communicatively coupleable to the memory resource. Each computing node may include a native memory management unit to manage a native memory on the computing resource and a memory resource memory management unit to manage the memory resource region of the memory resource associated with the computing resource.

### BACKGROUND

A computing device (e.g., desktop computer, notebook computer, server, cluster of servers, etc.) may incorporate various autonomous computing resources to add functionality to and expand the capabilities of the computing device. These autonomous computing resources may be various types of computing resources (e.g., graphics cards, network cards, digital signal processing cards, etc.) that may include computing components such as processing resources, memory resources, management and control modules, and interfaces, among others. These autonomous computing resources may share resources with the computing device and among one another.

### BRIEF DESCRIPTION OF THE DRAWINGS

The following detailed description references the drawings, in which:

FIG. 1 illustrates a block diagram of a computing system including a computing resource communicatively coupleable to a memory resource according to examples of the present disclosure;

FIG. 2 illustrates a block diagram of a computing system including a memory resource communicatively coupleable to a plurality of computing resources according to examples of the present disclosure;

FIG. 3 illustrates a block diagram of a computing system including a memory resource communicatively coupleable to a plurality of computing resources according to examples of the present disclosure; and

FIG. 4 illustrates a flow diagram of a method for translating data requests between a native memory address and a physical memory address of a memory resource by a memory resource memory management unit according to examples of the present disclosure.

### DETAILED DESCRIPTION

A computing device (e.g., desktop computer, notebook computer, server, cluster of servers, etc.) may incorporate autonomous computing resources to expand the capabilities of and add functionality to the computing device. For example, a computing device may include multiple autonomous computing resources that share resources such as memory and memory management (in addition to the autonomous computing resources' native computing components). In such an example, the computing device may include a physical memory, and the autonomous computing resource may be assigned virtual memory spaces within the physical memory of the computing device. These computing resources, which may include systems on a chip (SoC) and other types of computing resources, that share a physical memory need memory management services maintained outside of the individual memory system address domains native to the computing resource.

In some situations, individual and autonomous compute resources manage the memory address space and memory domain at the physical memory level. However, these computing resources cannot co-exist to share resources with other individual and autonomous computing resources in a common physical memory domain. Moreover, these computing resources have limited physical address bits.

Various implementations are described below by referring to several examples of a computing resource with memory resource memory management. In one example according to aspects of the present disclosure, a computing system includes a memory resource having a plurality of memory resource regions and a plurality of computing resources. The plurality of computing resources are communicatively coupleable to the memory resource. Each computing node may include a native memory management unit to manage a native memory on the computing resource and a memory resource memory management unit to manage the memory resource region of the memory resource associated with the computing resource.

In some implementations, the present disclosure provides for managing and allocating physical memory to multiple autonomous compute and I/O elements in a physical memory system. The present disclosure enables a commodity computing resource to function transparently in the physical memory system without the need to change applications and/or operating systems. The memory management functions are performed on the computing resource side of the physical memory system and are in addition to the native memory management functionality of the computing resource. Moreover, the memory management functions provide computing resource virtual address space translation to the physical address space of the physical memory system. Other address translation may also be performed, such as translation on process ID, user ID, or other computing resource dependent feature translation. These and other advantages will be apparent from the description that follows.

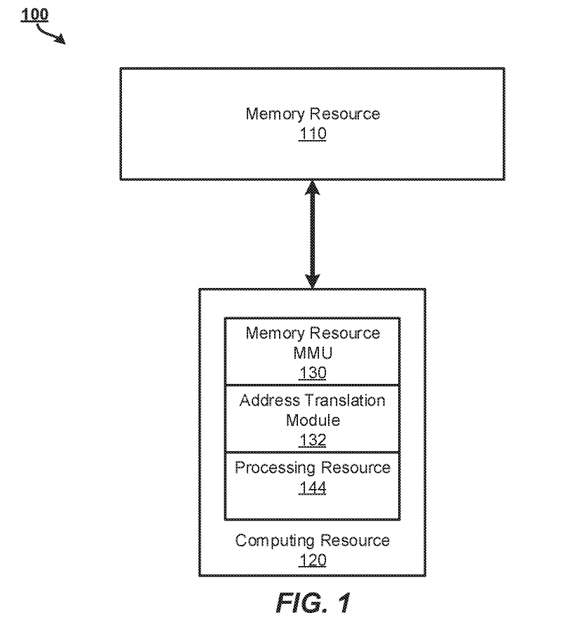

FIGS. 1-3 include particular components, modules, instructions etc. according to various examples as described herein. In different implementations, more, fewer, and/or other components, modules, instructions, arrangements of components/modules/instructions, etc. may be used according to the teachings described herein. In addition, various components, modules, etc. described herein may be implemented as instructions stored on a computer-readable storage medium, hardware modules, special-purpose hardware (e.g., application specific hardware, application specific integrated circuits (ASICs), embedded controllers, hardwired circuitry, etc.), or some combination or combinations of these.

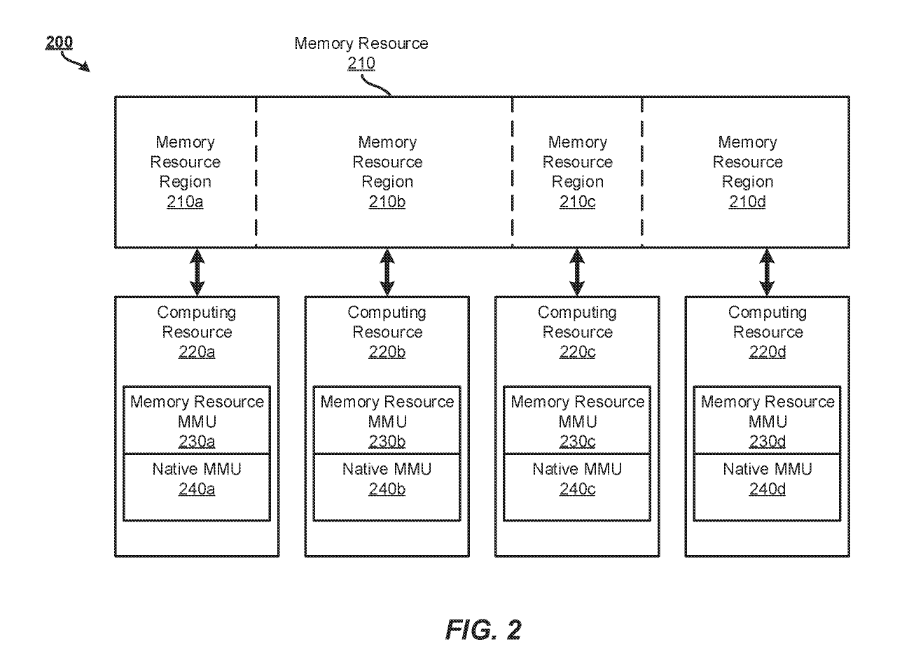

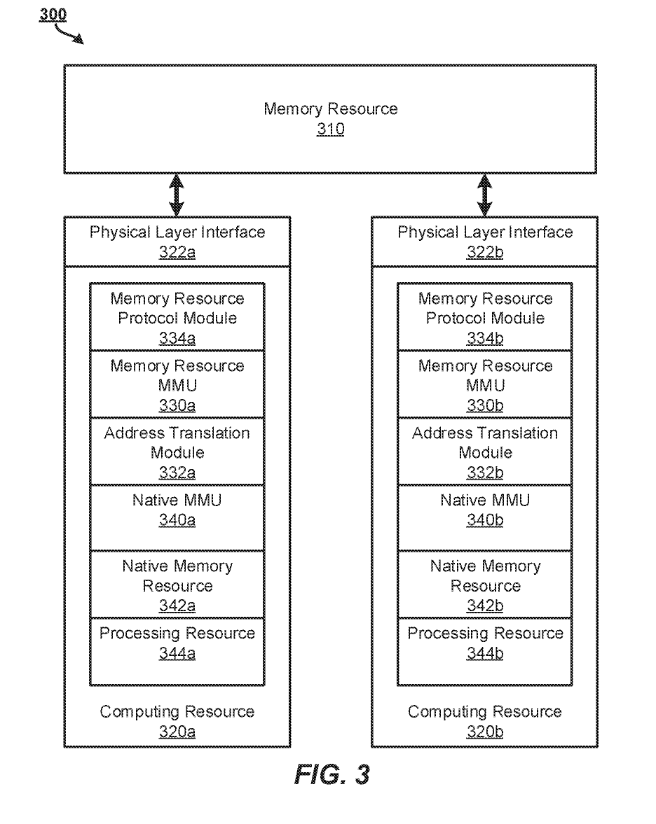

Generally, FIGS. 1-3 relate to components and modules of a computing system, such as computing system 100 of FIG. 1, computing system 200 of FIG. 2, and/or computing system 300 of FIG. 3. It should be understood that the computing systems 100, 200, and 300 may include any appropriate type of computing system and/or computing device, including for example smartphones, tablets, desktops, laptops, workstations, servers, server arrays or clusters, distributed computing systems, smart monitors, smart televisions, digital signage, scientific instruments, retail point of sale devices, video walls, imaging devices, peripherals, networking equipment, or the like or appropriate combinations thereof.

FIG. 1 illustrates a block diagram of computing system 100 including a computing resource 120 communicatively coupleable to a memory resource 110 according to examples of the present disclosure. The computing resource 120 is communicatively coupleable to a memory resource 110, which may have a plurality of memory resource regions (not shown). In examples, one of the memory resource regions is associated with the computing resource 120 so that the computing resource 120 may read data from and write data to the memory resource region of the memory resource 110 associated with the computing resource 120. The computing resource 120 may include a processing resource 144 to execute instructions on the computing resource and to read data from and write data to a memory resource region of the memory resource 110 associated with the computing resource 120.

The process resource 144 represents generally any suitable type or form of processing unit or units capable of processing data or interpreting and executing instructions. The processing resource 144 may be one or more central processing units (CPUs), microprocessors, and/or other hardware devices suitable for retrieval and execution of instructions. The instructions may be stored, for example, on a non-transitory tangible computer-readable storage medium such as memory resource 110, which may include any electronic, magnetic, optical, or other physical storage device that store executable instructions. Thus, the memory resource 110 may be, for example, random access memory (RAM), electrically-erasable programmable read-only memory (EPPROM), a storage drive, an optical disk, and any other suitable type of volatile or non-volatile memory that stores instructions to cause a programmable processor to execute the stored instructions.

In examples, the computing resource 120 is one of a system on a chip, a digital signal processing unit, and a graphic processing unit. Alternatively or additionally, the computing resource 120 may be dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

In addition to the processing resource 144, the computing resource 110 may include a memory resource memory management unit (MMU) 130 and an address translation module 132. In one example, the modules described herein may be a combination of hardware and programming. The programming may be processor executable instructions stored on a tangible memory resource such as memory resource 110, and the hardware may include processing resource 144 for executing those instructions. Thus memory resource 110 can be said to store program instructions that when executed by the processing resource 144 implement the modules described herein. Other modules may also be utilized as will be discussed further below in other examples.

The memory resource MMU 130 manages the memory resource region (not shown) of the memory resource 110 associated with the computing resource 120. The MMU 130 may use page tables containing page table entries to map virtual address locations to physical address locations of the memory resource 110.

The memory resource MMU 130 may enable data to be read from and data to be written to the memory resource region of the memory resource 110 associated with the computing resource 120. To do this, the memory resource MMU 130 may cause the address translation module 132 to perform a memory address translation to translate between a native memory address location of the computing resource 120 and a physical memory address location of the memory resource 110. For example, if the computing resource 120 desires to read data stored in memory resource region associated with the computing resource 120, the memory resource MMU 130 may cause the address translation module 132 to translate a native memory address location to a physical memory address location of the memory resource 110 (and being within the memory resource region associated with the computing resource 120) to retrieve and read the data stored in the memory resource 110. Moreover, in examples, the address translation module 132 may utilize a translation lookaside buffer (TLB) to avoid accessing the memory resource 110 each time a virtual address location of the computing resource 120 is mapped to a physical address location of the memory resource 110.

The memory resource MMU 130 may provide address space access and isolation, address space allocation, bridging and sharing between and among address spaces, address mapping fault messaging and signaling, distributed access mapping tables and mechanisms for synchronization, and fault and error handling and messaging capabilities to the computing resource 120 and the memory resource 110.

FIG. 2 illustrates a block diagram of a computing system 200 including a memory resource 210 communicatively coupleable to a plurality of computing resources 220a-220d according to examples of the present disclosure. In the example of FIG. 2, the memory resource 210 includes a plurality of memory resource regions 210a-210d. The memory resource 210 may be a non-transitory tangible computer-readable storage medium, which may include any electronic, magnetic, optical, or other physical storage device that store executable instructions. Thus, the memory resource 210 may be, for example, random access memory (RAM), electrically-erasable programmable read-only memory (EPPROM), a storage drive, an optical disk, and any other suitable type of volatile or non-volatile memory that stores instructions to cause a programmable processor to execute the stored instructions.

The memory resource 210 may be divided into memory resource regions 210a-210d, which may vary in size. In examples, a system administrator or other user, or an external memory controller, may allocate one of the memory resource regions 210a-210d to each of the computing resources 220a-220d respectively such that each of the memory resource region is associated with a computing resource. For example, as shown in FIG. 2, memory resource region 210a is associated with computing resource 220a, memory resource region 210b is associated with computing resource 220b, memory resource region 210c is associated with computing resource 220c, and memory resource region 210d is associated with computing resource 220d. The size of each memory resource region 210a-210d may be assigned statically or dynamically and may be assigned automatic or manual by a user or by another component such as an external memory controller.

In examples, the memory resource regions 210a-210d not associated with a particular computing resource 220a-220d are inaccessible to the other computing resources. For instance, memory resource region 210b, if associated with computing resource 220b, is inaccessible to the computing resources 220a, 220b, and 220d.

The computing system 200 also includes a plurality of computing resources 220a-220d that are communicatively coupleable to the memory resource 210. Each of the computing resources may include a native memory management unit (MMU) 240a-240d to manage a native memory on the computing resource, and a memory resource memory management unit (MMU) 230a-230d to manage the memory resource region of the memory resource associated with the computing resource.

The native MMU 240a-240d manages a native memory (not shown), such as a cache memory or other suitable memory, on the computing resource. Such a native memory may be used in conjunction with a processing resource (not shown) on the computing resources to store instructions executable by the processing resource. The native MMU 240a-240d cannot manage the memory resource 210 however.

Instead, the memory resource MMU 230a-230d manages the memory resource region 210a-210d associated with the computing resource 220a-220d. Further, the memory resource MMU 230a-230d may read data from and write data to the memory resource region 210a-210d associated with the computing resource 220a-220d. To do this, the memory resource MMU 230a-230d may perform a memory address translation to translate between a native memory address location of the computing resource and a physical memory address location of the memory resource. For example, if the computing resource 220a desires to read data stored in memory resource region 210a, the memory resource MMU 230a may translate a native memory address location to a physical memory address location of the memory resource 210 (and being within the memory resource region 210a) to retrieve and read the data stored in the memory resource region 210a. In other examples, the computing resources 220a-220d may include an address translation module (such as address translation module 132 of FIG. 1) to perform the address translation.

In examples, the memory resource MMU 230a-230d may be controlled by a memory controller (not shown) in the computing system 200 and external to the computing resource 220a-220d. The memory controller may aid associating the memory resource regions 210a-210d with the respective computing resources 220a-220d, including reassociating the memory resource regions 210a-210d as may be desirable. The memory controller external to the computing resources 220a-220d may be any suitable computing resource to control the memory resource MMU 230a-230d.

In examples, at least one of the computing resources 220a-220d may include a processing resource to execute instructions on the computing resource and to read data from and write data to the memory resource region 210a-210d of the memory resource 210 associated with the computing resource 210a-210d. As described herein, it should be understood that the computing resource 220a-220d may include other additional components, modules, and functionality.

FIG. 3 illustrates a block diagram of a computing system 300 including a memory resource 310 communicatively coupleable to a plurality of computing resources 320a, 320b according to examples of the present disclosure. In examples, the memory resource 310 may be a non-transitory tangible computer-readable storage medium, which may include any electronic, magnetic, optical, or other physical storage device that store executable instructions. Thus, the memory resource 310 may be, for example, random access memory (RAM), electrically-erasable programmable read-only memory (EPPROM), a storage drive, an optical disk, and any other suitable type of volatile or non-volatile memory that stores instructions to cause a programmable processor to execute the stored instructions.

The computing resources 320a, 320b may include at least: a physical layer interface 322a, 322b; a memory resource protocol module 334a, 334b; a memory resource MMU 330a, 330b; an address translation module 332a, 332b; a native MMU 340a, 340b; a native memory resource 342a, 342b; and a processing resource 344a, 344b. Various combinations of these components and/or subcomponents may be implemented in other examples, such that some components and/or subcomponents may be omitted while other components and/or subcomponents may be added.

The physical layer interface 322a, 322b represents an interface to communicatively couple the computing resource 320a, 320b and the memory resource 310. For example, the physical layer interface 322a, 322b may represent a variety of market-specific and/or proprietary interfaces (e.g., copper, photonics, varying types of interposers, through silicon via, etc.) to communicatively couple the computing resource 320a, 320b to the memory resource 310. In examples, switches, routers, and/or other signal directing components may be implemented between the memory resource 310 and the physical layer interface 322a, 322b of the computing resource 320a, 320b.

The memory resource protocol module 334a, 334b performs data transactions between the memory resource 310 and the computing resource 320a, 320b. For example, the memory resource protocol module 344a, 344b reads data from and writes data to the one of the memory resource regions being associated with the computing resource 334a, 334b.

The memory resource MMU 330a, 330b manages the memory resource region associated with the computing resource 320a, 320b. Further, the memory resource MMU 330a, 330b may read data from and write data to the memory resource region 310a, 310b associated with the computing resource 320a, 320b via the memory resource protocol module 334a, 334b in examples. To do this, the memory resource MMU 330a, 330b may cause the address translation module 332a, 332b to translate a native memory address location to a physical memory address location of the memory resource 310 (and being within the memory resource region associated with the computing resource 320a, 320b) to retrieve and read the data stored in the memory resource 310.

As discussed, the address translation module 332a, 332b performs a memory address translation to translate between a native memory address location of the computing resource 320a, 320b and a physical memory address location of the memory resource 310. For example, if the computing resource 320a desires to read data stored in memory resource region associated with the computing resource 320a, the memory resource MMU 330a may cause the address translation module 332a to translate a native memory address location to a physical memory address location of the memory resource 310 (and being within a memory resource region associated with the computing resource 320a) to retrieve and read the data stored in the memory resource 310. Moreover, the address translation module 332a may utilize a translation lookaside buffer (TLB) to avoid accessing the memory resource 310 each time a virtual address location of the computing resource 320a is mapped to a physical address location of the memory resource 310.

The native MMU 340a, 340b manages a native memory resource 342a, such as a cache memory or other suitable memory, on the computing resource 320a, 320b. Such a native memory resource 342a, 342b may be used in conjunction with the processing resource 344a, 344b on the computing resources 320a, 320b to store instructions executable by the processing resource 344a, 344b. The native MMU 340a, 340b cannot manage the memory resource 310 however. In examples, the native MMU 340a, 340b may be unaware of the memory resource 310 such that when the processing resource 344a, 344b reads data from or writes data to the memory resource 310, the native MMU 340a, 340b is unaware that the memory resource 310 exists, even though the data is read from or written to the memory resource 310. In this way, the memory resource 310 is transparent to the native MMU 340a, 340b by imposing abstraction.

The processing resource 344a, 344b represents generally any suitable type or form of processing unit or units capable of processing data or interpreting and executing instructions. The processing resource 344a, 344b may be one or more central processing units (CPUs), microprocessors, and/or other hardware devices suitable for retrieval and execution of instructions. The instructions may be stored, for example, on a non-transitory tangible computer-readable storage medium such as memory resource 310, which may include any electronic, magnetic, optical, or other physical storage device that store executable instructions. Thus, the memory resource 310 may be, for example, random access memory (RAM), electrically-erasable programmable read-only memory (EPPROM), a storage drive, an optical disk, and any other suitable type of volatile or non-volatile memory that stores instructions to cause a programmable processor to execute the stored instructions.

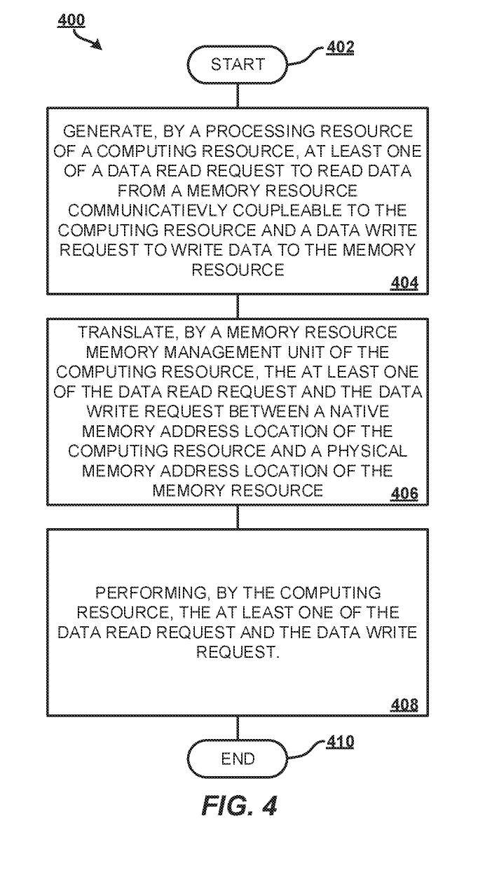

FIG. 4 illustrates a flow diagram of a method 400 for translating data requests between a native memory address and a physical memory address of a memory resource by a memory resource memory management unit according to examples of the present disclosure. The method 400 may be executed by a computing system or a computing device such as computing systems 100, 200, and/or 300 of FIGS. 1-3 respectively. The method 400 may also be stored as instructions on a non-transitory computer-readable storage medium (e.g., memory resource 110, 210a-210d, and/or 310a, 310b of FIGS. 1-3 respectively) that, when executed by a processor (e.g., processing resource 144, 244a-244d, and/or 344a, 344b), cause the processor to perform the method 400.

At block 402, the method 400 begins and continues to block 404. At block 404, the method 400 includes a processing resource (e.g., processing resource 144 of FIG. 1) of a computing resource (e.g., computing resource 120 of FIG. 1) generating at least one of a data read request to read data from a memory resource (e.g., memory resource 110 of FIG. 1) communicatively coupleable to the computing resource and a data write request to write data to the memory resource. The method 400 continues to block 406.

At block 406, the method 400 includes a memory resource memory management unit (e.g., memory resource MMU 130 of FIG. 1) of the computing resource translating the at least one of the data read request and the data write request between a native memory address location of the computing resource and a physical memory address location of the memory resource. In examples, the physical memory address location is located in a region of the memory resource associated with the computing resource. In additional examples, the native memory address location is at least one of a native physical address location and a native virtual memory address location. The translating may be performed, for example, by an address translation module such as address translation module 132 of FIG. 1 independently from or in conjunction with the memory resource memory management unit. The method 400 continues to block 408.

At block 408, the method 400 includes the computing resource performing the at least one of the data read request and the data write request. The method 400 continues to block 410 and terminates.

Additional processes also may be included, and it should be understood that the processes depicted in FIG. 4 represent illustrations, and that other processes may be added or existing processes may be removed, modified, or rearranged without departing from the scope and spirit of the present disclosure. While the method 400 is described with respect to components of FIG. 1, it should also be appreciated that components described with respect to FIGS. 2-4 may be substituted, added, or removed to perform the blocks described in method 400.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A computing system comprising:
a memory resource further comprising a plurality of memory resource regions; and
a plurality of computing resources communicatively coupleable to the memory resource, each computing resource further comprising:
a native memory management unit to manage a native memory on the computing resource, and
a memory resource memory management unit to manage the memory resource region of the memory resource associated with the computing resource.

2. The computing system of claims 1, wherein the computing resource further comprises:
a processing resource to execute instructions on the computing resource and to read data from and write data to the memory resource region of the memory resource associated with the computing resource.

3. The computing system of claim 1, wherein memory resource regions not associated with a particular computing resource are inaccessible to the other computing resources.

4. The computing system of claim 1, wherein the memory resource memory management unit performs a memory address translation between a native memory address location of the computing resource and a physical memory address location of the memory resource.

5. The computing system of claim 1, wherein the native memory management unit cannot manage the memory resource.

6. The computing system of claim 1, wherein the memory resource memory management unit is controlled by a memory controller in the computing system external to the plurality of computing resources.

7. A computing resource communicatively coupleable to a memory resource having a plurality of memory resource regions, one of the memory resource regions being associated with the computing resource, the computing resource comprising:
a processing resource to execute instructions on the computing resource and to read data from and write data to the memory resource region of the memory resource associated with the computing resource;
a memory resource memory management unit to manage the memory resource region of the memory resource associated with the computing resource; and
an address translation module to perform a memory address translation between a native memory address location of the computing resource and a physical memory address location of the memory resource using an address translation table.

8. The computing resource of claim 7, wherein the computing resource is selected from the group consisting of at least one of a system on a chip, a field-programmable gate array, a digital signal processing unit, and a graphic processing unit.

9. The computing resource of claim 7, further comprising:
a physical layer interface to communicatively couple the computing resource to the shared memory.

10. The computing resource of claim 7, further comprising:
a memory resource protocol module to perform reading data from and writing data to the one of the memory resource regions being associated with the computing resource.

11. The computing resource of claim 7, further comprising:
a native memory management unit to manage a native memory on the computing resource.

12. The computing resource of claim 11, wherein the native memory management unit further comprises a translation lookaside buffer.

13. A method comprising:
generating, by a processing resource of a computing resource, at least one of a data read request to read data from a memory resource communicatively coupleable to the computing resource and a data write request to write data to the memory resource;
translating, by a memory resource memory management unit of the computing resource, the at least one of the data read request and the data write request between a native memory address location of the computing resource and a physical memory address location of the memory resource; and
performing, by the computing resource, the at least one of the data read request and the data write request.

14. The method of claim 1, wherein the physical memory address location is located in a region of the memory resource associated with the computing resource.

15. The method of claim 1, wherein the native memory address location is at least one of a native physical address location and a native virtual memory address location.
